(19) United States
(12) Patent Application Publication
(10) Pub. No.: US 2013/0139046 A1
(43) Pub. Date: May 30, 2013

(54) COMPUTING DEVICE AND METHOD FOR GENERATING MEASUREMENT REPORT OF OBJECTS

(71) Applicants: CHIH-KUANG CHANG, Tu-Cheng (TW); LI JIANG, Shenzhen City (CN); ZHENG-CAI SHE, Shenzhen City (CN); YU-HUA XU, Shenzhen City (CN); ZHI-JUN ZOU, Shenzhen City (CN)

(72) Inventors: CHIH-KUANG CHANG, Tu-Cheng (TW); LI JIANG, Shenzhen City (CN); ZHENG-CAI SHE, Shenzhen City (CN); YU-HUA XU, Shenzhen City (CN); ZHI-JUN ZOU, Shenzhen City (CN)

(21) Appl. No.: 13/663,503

(22) Filed: Oct. 30, 2012

(30) Foreign Application Priority Data
Nov. 25, 2011 (CN) 201110380440.0

(51) Int. Cl. G06F 17/00; G06F 17/20

(52) U.S. Cl. 715/227

(57) ABSTRACT

A method generates a measurement report of an object using a computing device. The method obtains measurement data of feature elements of the object, processes the measurement data to obtain output data, and outputs the measurement data of the output data to the measurement report according to a report output way corresponding to a report format, wherein the report format is received from a selection of the user. The measurement report is stored in a storage device of the computing device, or displayed on a display device that is connected to the computing device.

### BACKGROUND

1. Technical Field

Embodiments of the present disclosure relate to data measurement systems and methods, and particularly to a computing device and method for generating a measurement report of an object using the computing device.

2. Description of Related Art

Measurement is an important phase in manufacturing and is closely related to product quality. If measurement data (e.g., tolerances of objects) are outputted to a measurement report (e.g., an EXCEL format file), a user usually inputs the measurement data to the measurement report manually. If a large mount of measurement data needs to be processed, it is inconvenient for the user to manually input such large mount of measurement data to the measurement report. Therefore, a more efficient method for generating a measurement report of the object is desired.

### BRIEF DESCRIPTION OF THE DRAWINGS

FIG. 1 is a block diagram of one embodiment of a computing device including a measurement report generating system.

FIG. 2 is a flowchart of one embodiment of a method for automatically generating a measurement report of an object using the computing device of the FIG. 1.

FIG. 3 is a detailed flowchart of step S11 in FIG. 2.

FIG. 4 is a schematic diagram illustrating an output interface on a display device of the computing device of the FIG. 1.

FIG. 5 is a schematic diagram illustrating a measurement report in a TXT file format.

FIG. 6 is a schematic diagram illustrating a measurement report in a Rtf file format.

FIG. 7 is a schematic diagram illustrating a header of the measurement report in FIG. 6.

FIG. 8 is a schematic diagram illustrating a measurement report in a DAT file format.

FIG. 9A is a schematic diagram illustrating a header of the measurement report in FIG. 8, and FIG. 9B is a schematic diagram illustrating a footer of the measurement report in FIG. 8.

FIG. 10 is a schematic diagram illustrating a setting file of the measurement report in the DAT file format and in an EXCEL file format.

FIG. 11 is a schematic diagram illustrating a measurement report in an EXCEL file format.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

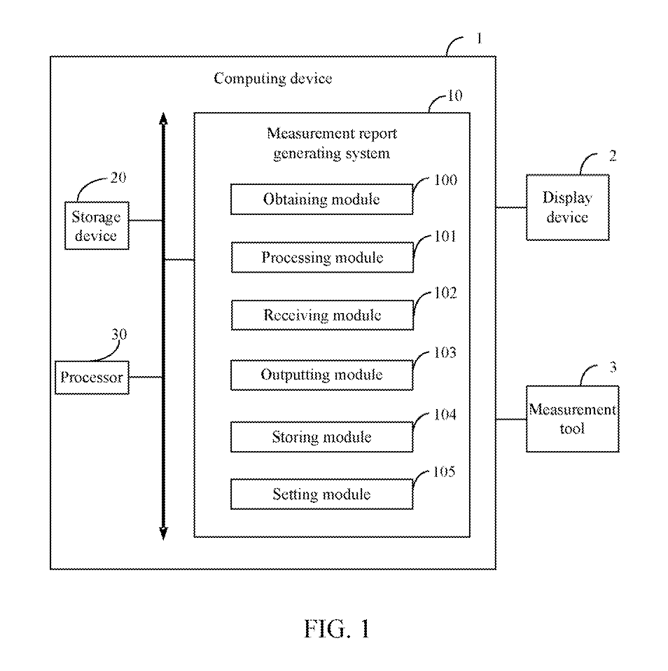

FIG. 1 is a block diagram of one embodiment of a computing device 1 including a measurement report generating system 10. In the embodiment, the computing device 1 further includes a storage device 20 and a processor 30. The computing device 1 connects to a display device 2 and a measurement tool 3. The computing device 1 may be a computer, a server, or any other computing device. The measurement report generating system 10 may be used to automatically obtain measurement data of feature elements of an object that is measured (hereinafter “the measured object”), and output the measurement data in different report formats (e.g., an EXCEL formatted file)) on the display device 2. The feature element may be a selected part of the measured object, such as a cover or a mobile phone, or a part of the cover of the mobile phone. In one embodiment, each “feature element” may be a line, a plane, a circle, a cylinder, or a sphere, but the disclosure is not limited thereto.

In one embodiment, the measurement data may include an identification number of a feature element of the measured object, a name of the feature element, a property of the feature element, an actual measuring value of the feature element, a reference value of the feature element, and a tolerance range of the feature element, but the disclosure is not limited thereto. The tolerance range includes an upper tolerance and a lower tolerance. The identification number is used to label and identify the feature element. The property is various measured characteristics describing the feature element, for example, a length of the feature element along an X-axis or along a Y-axis, and is used to locate an actual measured characteristics of the feature element. The actual measuring value is a true value of the feature element as measured. The reference value is used as a reference of the actual measuring value corresponding to the feature element. The tolerance range may be a predefined number range, for example, [−0.1, +0.1].

The storage device 20 stores the measurement data of the feature elements of the measured object. The display device 2 displays the measurement data of the feature elements of the measured object. The measurement tool 3 may be an image measuring machine to measure the measured object to obtain the measurement data. The storage device 20 may be an internal storage system, such as a random access memory (RAM) for temporary storage of information, and/or a read only memory (ROM) for permanent storage of information. In some embodiments, the storage device 20 may also be an external storage system, such as an external hard disk, a storage card, or a data storage medium.

In one embodiment, the measurement report generating system 10 may include one or more modules, for example, an obtaining module 100, a processing module 101, a receiving module 102, an outputting module 103, a storing module 104 and a setting module 105. The one or more modules 100-105 may comprise computerized code in the form of one or more programs that are stored in the storage device 20 of the computing device 1. The computerized code includes instructions that are executed by the at least one processor 30 to provide functions for the one or more modules 100-105. A detailed description of each module will be given in the following paragraphs.

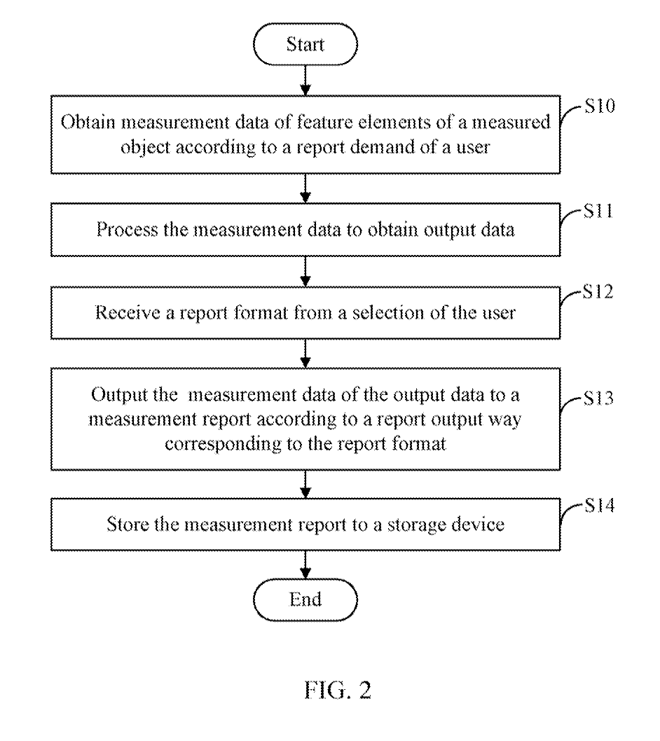

FIG. 2 is a flowchart of one embodiment of a method for automatically generating a measurement report of an object using the computing device 1. Depending on the embodiment, additional steps may be added, others removed, and the ordering of the steps may be changed.

In step S10, the obtaining module 100 obtains the measurement data of feature elements of the measured object from the storage device 20 according to a report demand of a user. In one embodiment, the user may need kinds of measurement data to output to a measurement report that includes the measurement data and calculated data based on the measurement data.

In one embodiment, the storage device 20 may store a lot of measurement data. The user may not require that all the measurement data need to be outputted to the measurement report. In one embodiment, the user may select different kinds of the measurement data on the display device 2 according to the report demand of the user.

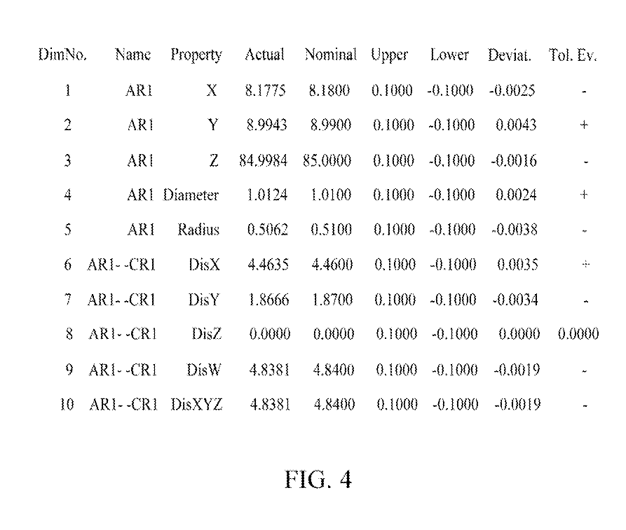

Referring to FIG. 4, which is an output interface on the display device 2 of the embodiment. The display device 2 displays the different kinds of the measurement data. The user selects the kinds of measurement data required on the output interface. In FIG. 4, the different kinds of the measurement data may include the identification number (named as “DimNo.” in FIG. 4), the name, the property, the actual measuring value (named as “Actual” in FIG. 4), the reference value (named as “Nominal” in FIG. 4), the upper tolerance (named as “Upper” in FIG. 4), the lower tolerance (named as “Lower” in FIG. 4), a deviation (named as “Deviat.” in FIG. 4) and a tolerance evaluation (named as “Tol.Ev” in FIG. 4). The tolerance value and the tolerance evaluation are the calculated data, and other data in FIG. 4 are the measurement data. The deviation is a value of the feature element that can be obtained from the actual measuring value and the reference value. The tolerance evaluation is a sign of the feature element that can be obtained from the deviation.

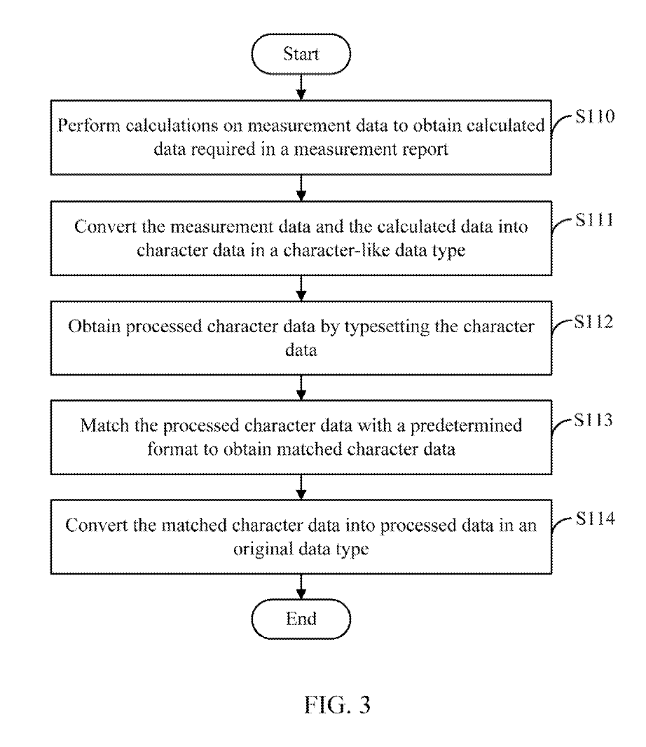

In step S11, the processing module 101 processes the measurement data to obtain output data. A detailed description of step S11 will be given in FIG. 3.

In step S12, the receiving module 102 receives a report format from a selection of the user. In one embodiment, the report format may be a TXT file format, a Rtf file format, a DAT file format, an EXCEL file format, a comma separated values (hereinafter “CSV”) file format, for example.

In one embodiment, the setting module 105 sets different report output ways corresponding to different report formats. The report output way may export the measurement data of the output data to the measurement report in a default format, where the default format indicates that the kinds of the measurement data of the measurement report are the same as the kinds of the measurement data of the output data, and an order of the measurement data of the measurement report are the same as an order of the measurement data of the output data. The TXT file format and the Rtf file format export the measurement data of the output data to the measurement report in the default format.

In one embodiment, the report output way may fill in the measurement report with the measurement data of the output data in a preset format, where the preset format indicates that the measurement data of the measurement report sorts in a preset order, and the kinds of measurement data of the measurement report are different from the kinds of the measurement data of the output data. Some kinds of measurement data that does not belong to the output data may be added to the measurement report, or some kinds of measurement data of the output data may be removed from the measurement report. The DAT file format fills the measurement data of the output data to the measurement report in the preset format.

In one embodiment, the report output way may fill in the measurement report with the measurement data of the output data according to a report format inputted by the user. The EXCEL file format fills the measurement data of the output data to the measurement report according to the report format inputted by the user.

In step S13, the outputting module 103 outputs the measurement data of the output data to the measurement report according to the report output way corresponding to the report format.

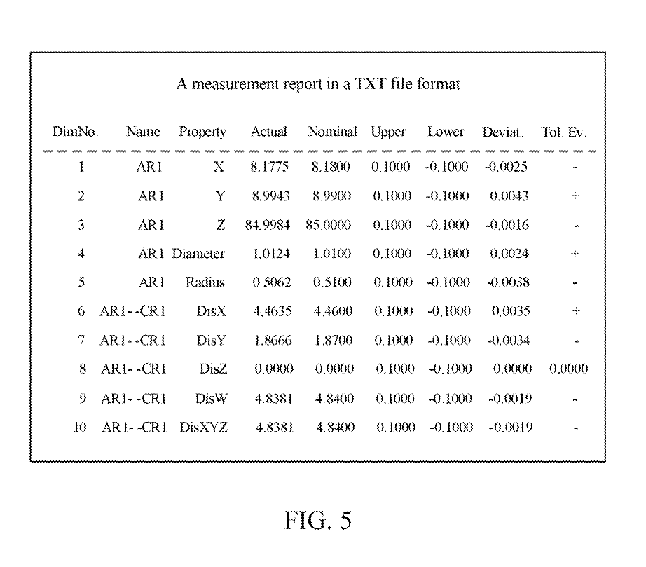

In one embodiment, the measurement data of the output data is exported to a TXT file directly in the default format. In one example of FIG. 4, the measurement data is exported to a TXT file in the default format, and generates the measurement report in FIG. 5.

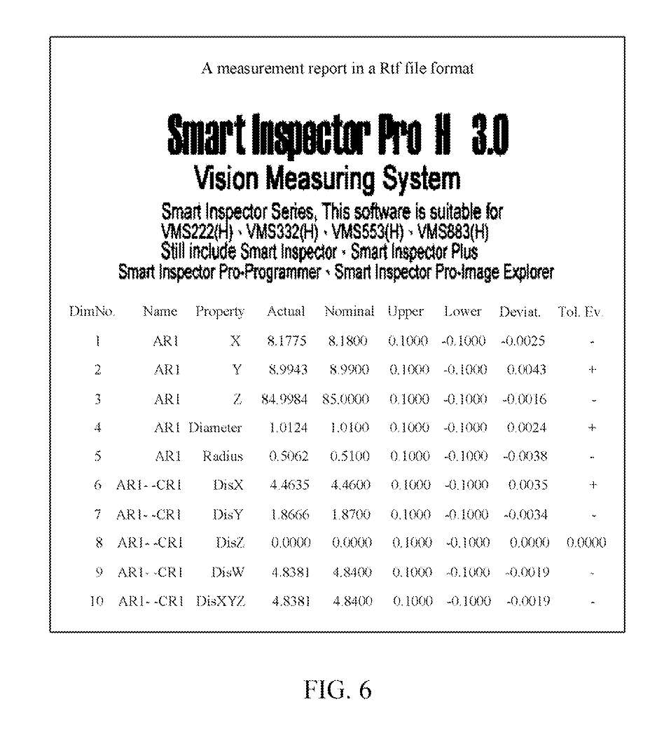

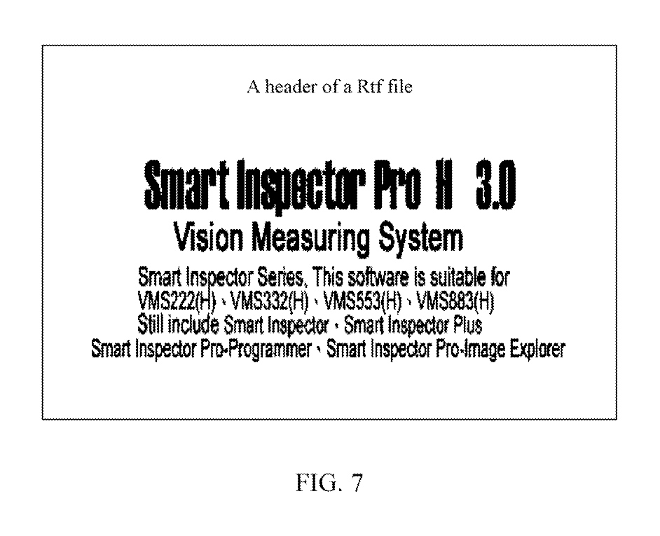

In one embodiment, the measurement data of the output data is exported to a Rtf file directly in the default format. In one example with respect to FIG. 4, the measurement data is exported to a Rtf file in the default format, and generates the measurement report in FIG. 6. In FIG. 6, a header of the Rtf file is set by the user. The header of the Rtf file is shown as FIG. 7. Referring to FIG. 4, the measurement report in the Rtf file format may display a column of data with a mark on the output interface, but the measurement report in the Txt file format does not display the column of data with the mark on the output interface. The mark may be a highlighted mark with different colors, such yellow, red or black.

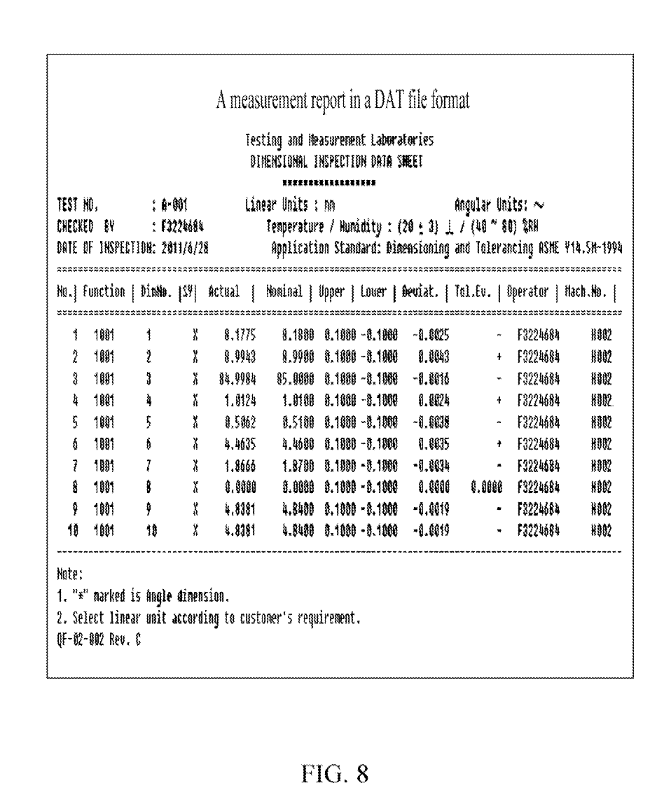

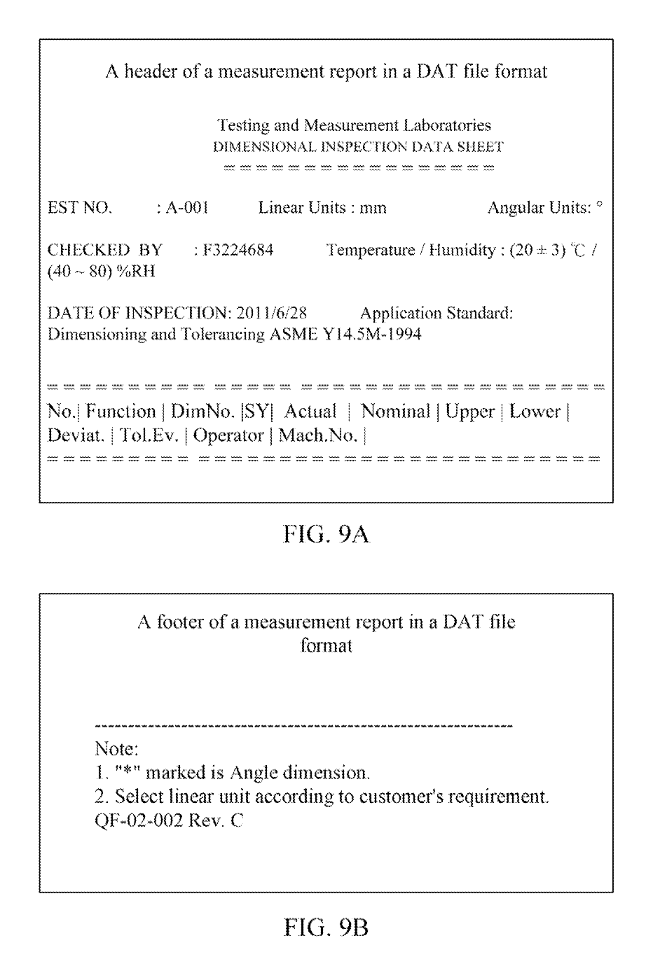

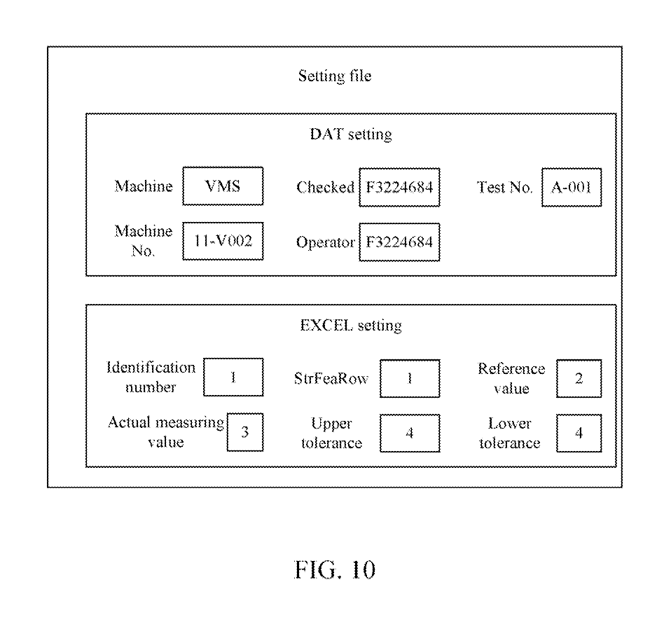

In one embodiment, the measurement data of the output data is filled to a TXT file in the preset format. In one example of FIG. 4, the measurement data is filled to a TXT file in the preset format, and generates the measurement report in FIG. 8. In FIG. 8, a header of the TXT file and a footer of the TXT file are set by the user. The header of the TXT file is shown as FIG. 9A, and the footer of the TXT file is shown as FIG. 9B. The measurement data of the measurement report in the DAT file format that cannot be obtained from the output data is set by a setting file. The setting file can be set by the user on the display device 2. The setting file is shown as FIG. 10. In FIG. 10, the setting file includes a DAT setting and an EXCEL setting, wherein the DAT setting is used to the measurement report in the DAT file format and the EXCEL setting is used to the measurement report in the EXCEL file format. The EXCEL setting can receive the report format inputted by the user.

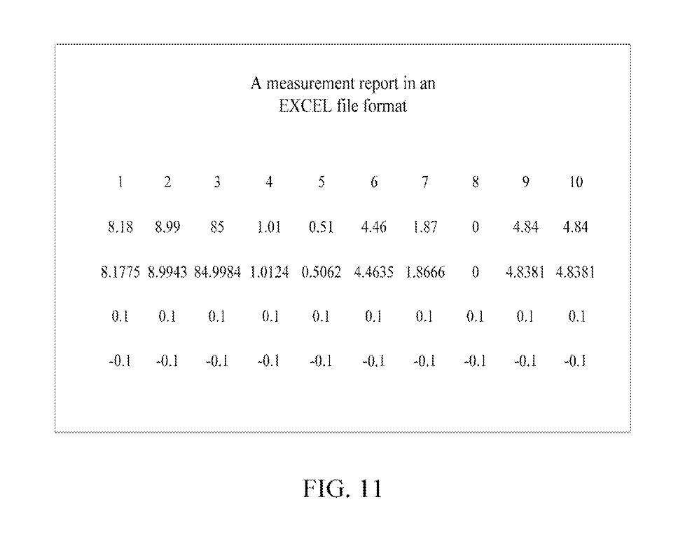

In one embodiment, the measurement data of the output data is filled to an EXCEL file according to the report format inputted by the user in the setting file. In one example of FIG. 4, the measurement data is filled to an EXCEL file according to the report format inputted by the user in the EXCEL setting, and generates the measurement report in FIG. 11.

In step S14, the storing module 104 stores the measurement report to the storage device 20. In other embodiments, the measurement report can also be displayed on the display device 2.

FIG. 3 is a detailed flowchart of step S11 in FIG. 2. Depending on the embodiment, additional steps may be added, others removed, and the ordering of the steps may be changed.

In step S110, the processing module 101 performs calculations on the measurement data to obtain calculated data required in the measurement report. The calculated data cannot be obtained from the measurement data, such as a deviation and a tolerance evaluation.

In step S111, the processing module 101 converts the measurement data and the calculated data into character data in a character-like data type.

In step S112, the processing module 101 obtains processed character data by typesetting the character data. The typesetting may be set an alignment mode (e.g., left-aligned or right-aligned), or adjust the length of the character data (e.g., if the length of the character data exceeds a default length, intercept the length), for example.

In step S113, the processing module 101 matches the processed character data with a predetermined format to obtain matched character data, wherein the predetermined format is used to sort the processed character data in a predefined order. As shown in FIG. 4, the predetermined format is that the processed character data is sorted in the predefined order as follows: the identification number, the name, the property, the actual measuring value, the reference value, the upper tolerance, the lower tolerance, the deviation and the tolerance evaluation.

In step S114, the processing module 101 converts the matched character data into processed data in an original data type. The processed data are described as the FIG. 4. The processed data is stored to the storage device 20 as the output data.

Prior to this disclosure, the measurement data of the feature elements are inputted by the user manually to output in the measurement report. It may consume a lot of time and energy of the user to input the measurement data to the measurement report, and also may have many mistakes. In addition, the measurement report cannot be generated in different report formats. By this disclosure, the measurement data of the feature elements obtains from the measurement tool automatically. The measurement data can be outputted to the measurement report in different report format according the selection of the user.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computerized-implemented method of a computing device, the method comprising:
(a) obtaining measurement data of an object from a storage device of the computing device according to a report demand of a user;
(b) obtaining output data of a measurement report from the measurement data;
(c) receiving a report format of the measurement report from a selection of the user; and
(d) generating the measurement report by outputting the output data to the measurement report according to a report output way corresponding to the report format, and displaying the measurement report on a display device connected to the computing device.

2. The method according to claim 1, before the step (c) but after the step (b) further comprising:
setting different report output ways of the measurement report corresponding to different report formats.

3. The method according to claim 2, wherein the report output way exports the output data to the measurement report in a default format, wherein the default format indicates that the measurement data of the measurement report are same as the measurement data of the output data, and an order of the measurement data of the measurement report are same as an order of the measurement data of the output data.

4. The method according to claim 2, wherein the measurement report is filled with the measurement data of the output data in a preset format, wherein the preset format indicates that the measurement data of the measurement report is sorted in a preset order, and the measurement data of the measurement report are different from the measurement data of the output data.

5. The method according to claim 2, wherein the measurement report is filled with the measurement data of the output data according to a report format set by the user.

6. The method according to claim 1, wherein the step (b) comprises:
performing calculations on the measurement data to obtain calculated data required in the measurement report;
converting the measurement data and the calculated data into character data in a character-like data type;
obtaining processed character data by typesetting the character data;
matching the processed character data with a predetermined format to obtain matched character data, wherein the predetermined format is used to sort the processed character data in a predefined order; and
converting the matched character data into processed data in an original data type as the output data.

7. A computing device, comprising:
a storage device;
at least one processor; and
one or more modules that are stored in the storage device and are executed by the at least one processor, the one or more modules comprising:
an obtaining module that obtains measurement data of an object from the storage device according to a report demand of a user;
a processing module that obtains output data of a measurement report from the measurement data;
a receiving module that receives a report format of the measurement report from a selection of the user; and
an outputting module that generates the measurement report by outputting the output data to the measurement report according to a report output way corresponding to the report format.

8. The computing device according to claim 7, further comprising:
a setting module that sets different report output ways of the measurement report corresponding to different report formats.

9. The computing device according to claim 8, wherein the report output way exports the output data to the measurement report in a default format, wherein the default format indicates that the measurement data of the measurement report are same as the measurement data of the output data, and an order of the measurement data of the measurement report are same as an order of the measurement data of the output data.

10. The computing device according to claim 8, wherein the measurement report is filled with the measurement data of the output data in a preset format, wherein the preset format indicates that the measurement data of the measurement report is sorted in a preset order, and the measurement data of the measurement report are different from the measurement data of the output data.

11. The computing device according to claim 8, wherein the measurement report is filled with the measurement data of the output data according to a report format set by the user.

12. The computing device according to claim 7, wherein the processing module further performs calculations on the measurement data to obtain calculated data required in the measurement report, converts the measurement data and the calculated data into character data in a character-like data type, obtains processed character data by typesetting the character data, matches the processed character data with a predetermined format to obtain matched character data, and converts the matched character data into processed data in an original data type as the output data, wherein the predetermined format is used to sort the processed character data in a predefined order.

13. A non-transitory storage medium having stored thereon instructions that, when executed by a processor of a computing device, causes the computing device to perform a method, the method comprising:
(a) obtaining measurement data of an object from a storage device of the computing device according to a report demand of a user;
(b) obtaining output data of a measurement report from the measurement data;
(c) receiving a report format of the measurement report from a selection of the user; and
(d) generating the measurement report by outputting the output data to the measurement report according to a report output way corresponding to the report format.

14. The non-transitory storage medium according to claim 13, wherein the method further comprises:
setting different report output ways of the measurement report corresponding to different report formats.

15. The non-transitory storage medium according to claim 14, wherein the report output way exports the output data to the measurement report in a default format, wherein the default format indicates that the measurement data of the measurement report are same as the measurement data of the output data, and an order of the measurement data of the measurement report are same as an order of the measurement data of the output data.

16. The non-transitory storage medium according to claim 14, wherein the measurement report is filled with the measurement data of the output data in a preset format, wherein the preset format indicates that the measurement data of the measurement report is sorted in a preset order, and the measurement data of the measurement report are different from the measurement data of the output data.

17. The non-transitory storage medium according to claim 14, wherein the measurement report is filled with the measurement data of the output data according to a report format set by the user.

18. The non-transitory storage medium according to claim 13, wherein the step (b) comprises:
performing calculations on the measurement data to obtain calculated data required in the measurement report;
converting the measurement data and the calculated data into character data in a character-like data type;
obtaining processed character data by typesetting the character data;
matching the processed character data with a predetermined format to obtain matched character data, wherein the predetermined format is used to sort the processed character data in a predefined order; and
converting the matched character data into processed data in an original data type as the output data.
